(19) United States
(12) Patent Application Publication
(10) Pub. No.: US 2012/0194071 A1
(43) Pub. Date: Aug. 2, 2012

(54) Multi-tubular LED Light Bulb

(76) Inventor: David Huang, Taipei City (TW)

(21) Appl. No.: 13/173,000

(22) Filed: Jun. 30, 2011

(30) Foreign Application Priority Data
Jan. 31, 2011 (TW) 100202259

(51) Int. Cl. H01K 1/62

(52) U.S. Cl. 315/35

(57) ABSTRACT

The multi-tubular LED light bulb has a seat having a power plug, multiple glass tubes mounted on the seat, multiple multi-directional lighting LED strips respectively mounted inside the glass tubes and an AC to DC converting circuit board mounted inside the seat and connected to the power plug to obtain AC power and converting the AC power to DC power. The multi-directional lighting LED strips are electronically connected to the DC power source from the AC to DC converting circuit in parallel. Since the LED light bulb has multiple multi-directional lighting LED strips, different directional lightings and even brightness are provided. Further, heat from the LED strip is easily and quickly transmitted to the sidewall of the glass tube to expend the lifetime of the LED light bulb since the multi-directional lighting LED strips are close to a sidewall of the corresponding glass tube.

### BACKGROUND OF THE INVENTION

1. Field of the Invention

The present invention relates to the field of an LED light bulb, and more particularly to a multi-tubular LED light bulb.

2. Description of Related Art

The LED has the characteristic of lower energy consumption and is therefore used to be a light source of the illuminator. The traditional light source of the illuminator is replaced with the LED. With reference to FIG. 6, a conventional LED illuminator is an LED light bulb having a circular printed circuit board 50 and multiple LEDs 51 mounted on the circular printed circuit board.

Since the LED of the LED light bulb has directional lighting characteristic and all of the LEDs are mounted on a same face of the circular printed circuit board, the LED light bulb provides lighting in only one direction and limits an illuminating range. In addition, the LED light bulb does not provide high brightness since the area of the face of the circular printed circuit board is too small and the number of the LEDs is limited.

To overcome the shortcomings, the present invention provides a multi-tubular LED light bulb to mitigate or obviate the aforementioned problems.

### SUMMARY OF THE INVENTION

The main objective of the present invention is to provide a multi-tubular LED light bulb having high and even brightness.

The multi-tubular LED light bulb has a seat having a power plug, multiple glass tubes mounted on the seat, multiple multi-directional lighting LED strips respectively mounted inside the glass tubes and an AC to DC converting circuit board mounted inside the seat and connected to the power plug to obtain AC power and converting the AC power to DC power. The multi-directional lighting LED strips are electronically connected to the DC power source from the AC to DC converting circuit in parallel. Since the LED light bulb has multiple multi-directional lighting LED strips, different directional lightings and even brightness are provided. Further, heat from the LED strip is easily and quickly transmitted to the sidewall of the glass tube to expend the lifetime of the LED light bulb since the multi-directional lighting LED strips are close to a sidewall of the corresponding glass tube.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a multi-tubular LED light bulb in accordance with the present invention;

FIG. 2 is an exploded perspective view of the multi-tubular LED light bulb in accordance with the present invention;

FIG. 3A is a partial cross sectional view of FIG. 1;

FIG. 3B is a side plan view of another multi-tubular LED light bulb in accordance with the present invention;

FIG. 4 is a detailed circuit diagram of an AC to DC converting circuit board of the multi-tubular bulb in accordance with the present invention;

FIG. 5A is a top plan view of another multi-tubular LED light bulb in accordance with the present invention;

FIG. 5B is a top plan view of another multi-tubular LED light bulb in accordance with the present invention; and

FIG. 6 is a perspective view of a conventional LED light bulb in accordance with prior art.

### DETAILED DESCRIPTION OF THE PREFERRED EMBODIMENT

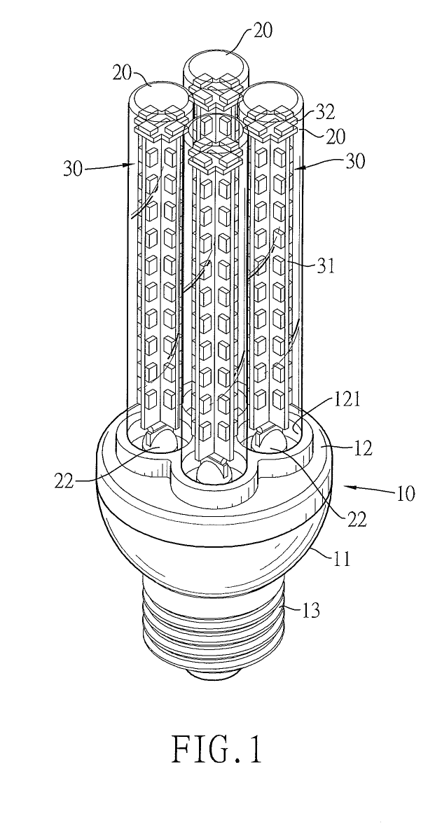

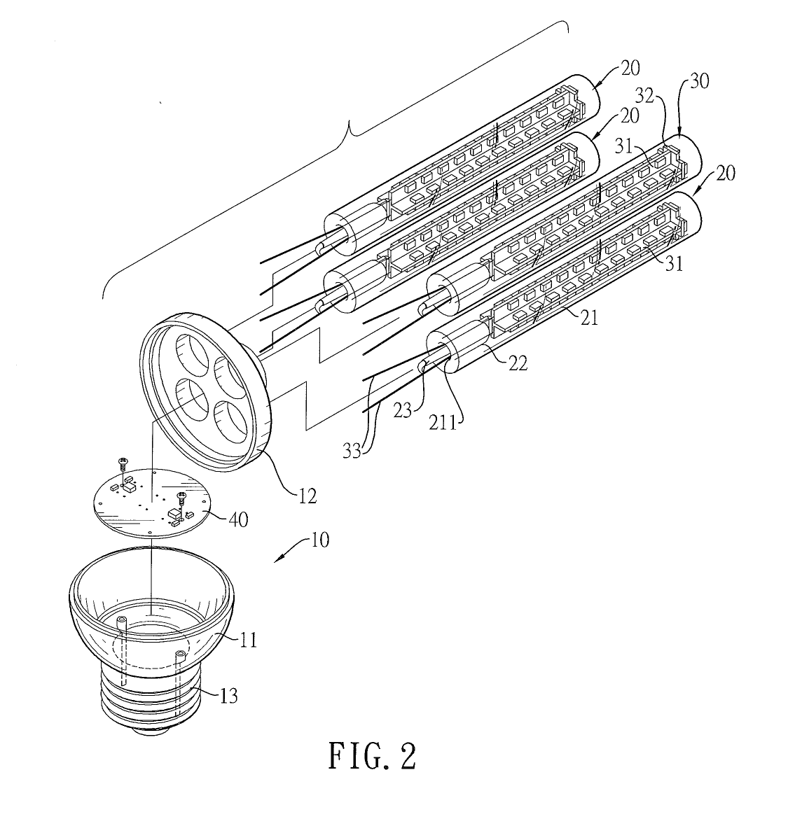

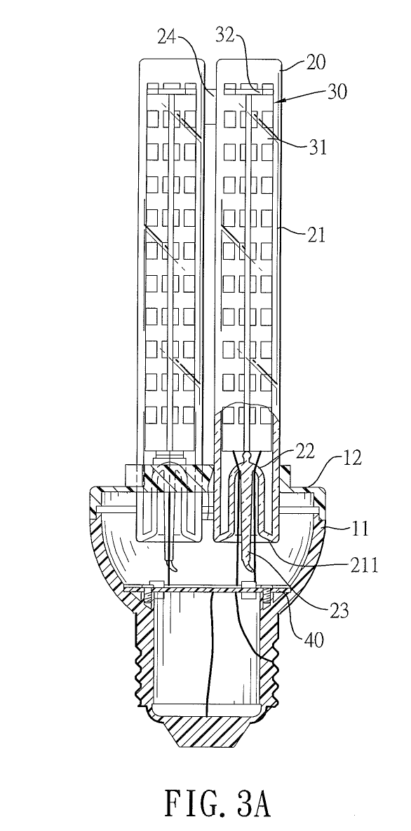

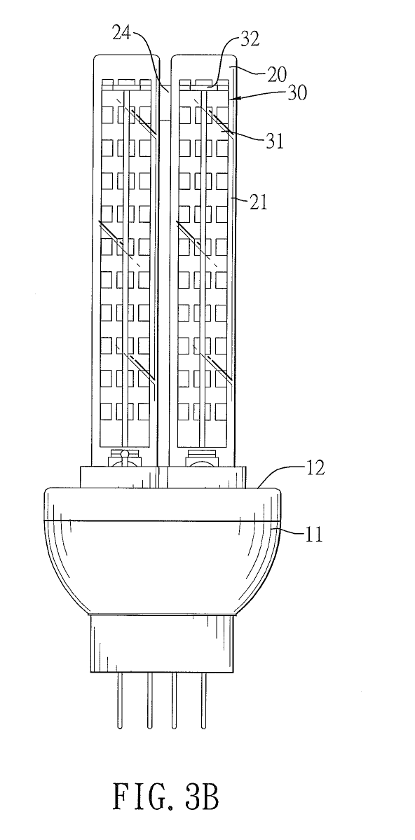

With reference to FIG. 1, FIG. 2 and FIG. 3A, a first embodiment of a multi-tubular LED light bulb has a seat 10, multiple glass tubes 20, multiple multi-directional lighting LED strips 30, and an AC to DC converting circuit board 40.

The seat 10 has a hollow base 11, a cover 12 and a power plug 13. The hollow base 11 has a top opening covered by the cover 12. Multiple through holes 121 are defined through the cover 12. The power plug 13 is mounted on a bottom of the hollow base 11. In the first embodiment, the type of the power plug is Edisson screw including E27, E14, B22 etc. With further reference to FIG. 3B, another embodiment of an LED light bulb may use the type G7, G10, G11, G23 or G24 etc. pin plug as a power plug.

The glass tubes 20 are respectively inserted into the corresponding through holes 121 of the seat 10, so that a bottom portion of each glass tube 20 is mounted on the seat 10. In the first embodiment, the LED light bulb 10 has four glass tubes 20 and may further has four supports 24 respectively connected between outsides of the two corresponding adjacent glass tubes 20. The support 24 may maintain a fixed gap between the two adjacent glass tubes 20. Each of the at least one support 24 has a length matching a distance between the two through hole 121, where the corresponding adjacent glass tubes 20 are inserted. Each glass tube 20 has a cylinder body 21, a bell-shaped bubble 22 and an airtight pipe 23. The bell-shaped bubble 22 is received inside the cylinder body 21 from a bottom opening 211 and a bottom of the bell-shaped bubble 22 is integrally connected to bottom edge of the cylinder body 21, wherein the bottom edge is formed around the bottom opening 211. The airtight pipe 23 downwardly extends from a top of the bell-shaped bubble 22 and communicates with an inner space of the cylinder body 21.

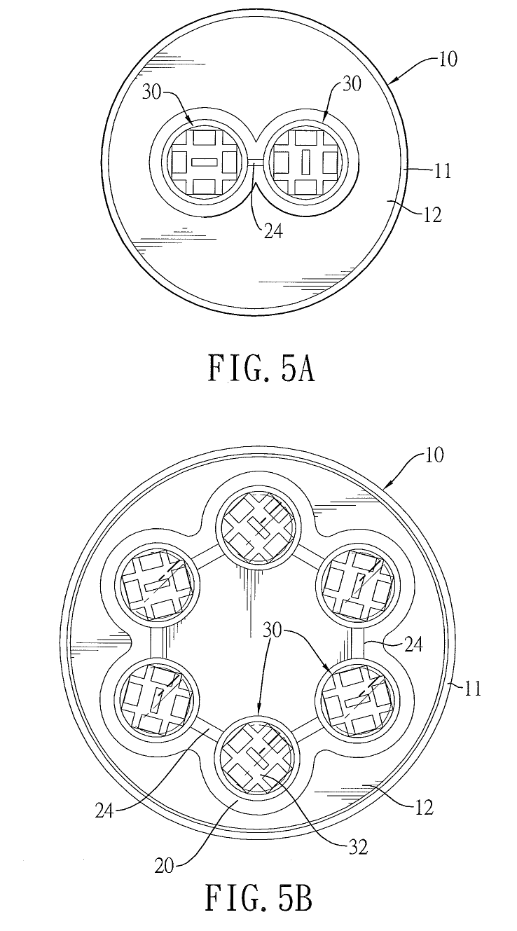

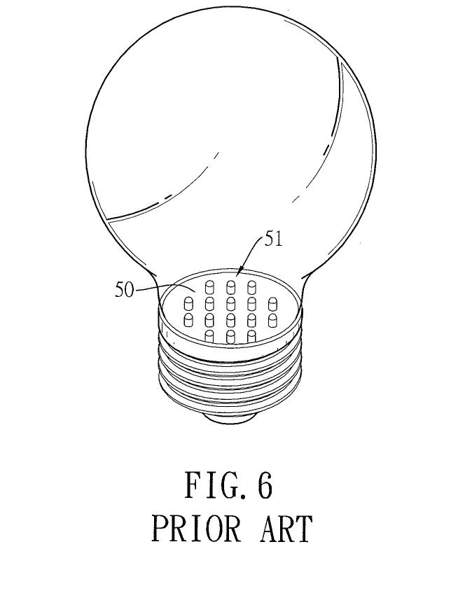

Multiple multi-directional lighting LED strips 30 are respectively mounted inside the glass tubes 20. Each multi-directional lighting LED strip 30 is mounted inside the corresponding glass tube 20 and has multiple lengthwise LED circuit boards 31, a lateral LED circuit board 32 and two power pins 33. In the preferred embodiment, four LED lengthwise circuit boards 31 are arranged in a cross shape and the lateral LED circuit board 32 is mounted across top of the lengthwise LED circuit boards 31. The power pins 33 are mounted on the lengthwise LED circuit boards 31 and passing through outside the bottom opening 211 of the glass tube 20. In a preferred embodiment, two power pins 33 are passing through a gap between the bell-shaped bubble 22 and the airtight pipe 23 and protruding outside the bottom opening 211 of the glass tube 20. Since multiple LEDs are mounted on two opposite sides of the lengthwise LED circuit boards 31, each lengthwise LED circuit 31 has two opposite lighting faces. Therefore, the multi-directional lighting LED strip 30 provides different directional lightings to have boarder lighting area. With further reference to FIGS. 5A and 5B, two or six multi-directional lighting LED strips 30 and glass tubes 20 are used in the present invention. The present invention does not limit numbers of the multi-directional lighting LED strips and the glass tubes.

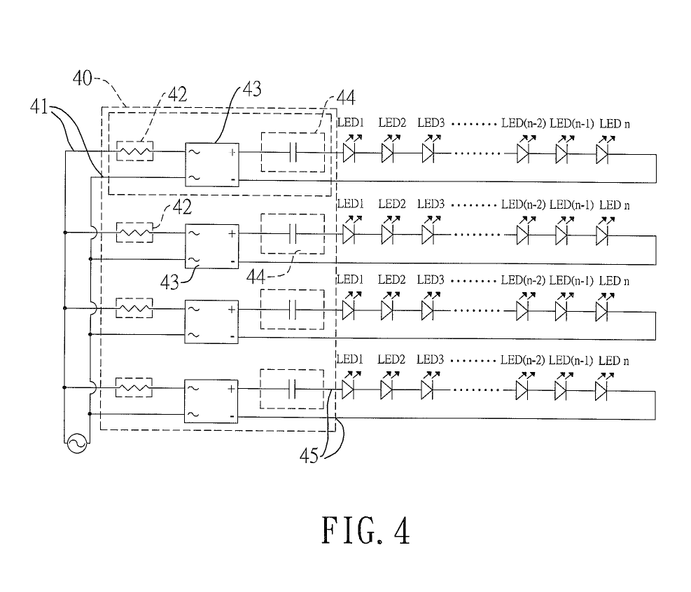

With further reference to FIG. 4, the AC to DC converting circuit board 40 is mounted in the hollow base 11 of the seat 10 and has AC power inputs 41 and DC power outputs 45. The AC power inputs 41 are connected to the power plug 13. The power pins 33 are connected to the DC power outputs 45 so the multi-directional lighting LED strips 30 are electronically connected to the DC power outputs 45 in parallel. The AC to DC converting circuit board 40 has multiple AC to DC power converters. Each AC to DC power converter has a current limiting resistor 42, a full bridge rectifier 43 and a capacitor 44. Inputs of the full bridge rectifier 43 are connected to the AC power inputs 41. The current limiting resistor 42 is connected between one of the AC power inputs 41 and one of the inputs of the full bridge rectifier 43, so the full bridge rectifier 43 obtains AC power from the power plug 13. Outputs of the full bridge rectifier 43 are connected to the DC power outputs 45. The capacitor 44 is connected between one of the outputs of the full bridge rectifier 43 and one of the DC power outputs 45. The full bridge rectifier 43 converts the AC power to the DC power and then outputs the DC power to the DC power outputs 45. The multi-directional lighting LED strips 30 are electronically connected to the DC power source in parallel to establish multiple parallel loops so that each multi-directional lighting LED strip 30 can be lighted individually.

In addition, the inner space of the glass tube 20 may be further filled with gas having high heat conductive coefficient, such as inert gas including neon or argon, or nitrogen. To draw the gas in the inner space of the glass tube 20, the multi-directional lighting LED board 30 is inserted into the inner space of the glass tube 20 from the bottom opening 211 thereof before forming the bell-shaped bubble and the airtight pipe. When the multi-directional lighting LED strip 30 is mounted inside the inner space of the glass tube 20, a preformed bell-shaped bubble 22 with a pipe having an opening is heated to adhere to the bottom edge of the cylinder body 21. Air in the inner space is drawn from the opening of the pipe until the inner space is vacuum. After then, the gas having high heat conductive coefficient is inserted into the inner space through the opening of the pipe 23 to prevent metal material on the circuit boards from being oxidized and the lifetime of the circuit boards is extended. In the final step, the opening of the pipe 23 is heated to be close to form the airtight pipe 23.

Based on the foregoing description, the LED light bulb has multiple multi-directional lighting LED strips and each LED strip has multiple lengthwise LED boards each of which has two lighting faces and a lateral LED board, so that the LED light bulb provides different directional lightings to have boarder lighting area and high and even brightness. In addition, since the glass tube is long and the multi-directional lighting LED strip is close to a sidewall of the glass tube, heat from the LED strip is easily and quickly transmitted to the sidewall of the glass tube to expend the lifetime of the LED light bulb.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A multi-tubular LED light bulb, comprising:
a seat having a top defined with multiple through holes, a bottom and a power plug mounted on the bottom;
multiple glass tubes respectively inserted into the through holes on the top of the seat and mounted on the seat;
multiple multi-directional lighting LED strips respectively mounted inside the glass tubes, each of which has:
multiple lengthwise LED circuit boards having two opposite lighting faces;
a lateral LED circuit board mounted on tops of the lengthwise LED circuit boards; and
two power pins mounted on the lengthwise LED circuit board and passing through a bottom of the corresponding glass tube; and
an AC to DC converting circuit board mounted inside the seat and having:
AC power inputs connected to the power plug to receive AC power; and
DC power outputs where the power pins of the multi-directional lighting LED strips are connected, supplying DC power; wherein the multi-directional lighting LED strips are electronically connected to the DC power source in parallel.

2. The LED light bulb as claimed in claim 1, wherein the base comprises:
a hollow base having a top opening and a bottom on which the power plug is mounted;
a cover, which the through holes are defined through, covering the top opening of the hollow base, wherein the through holes communicate with an inner space of the hollow base.

3. The LED light bulb as claimed in claim 2, further comprising at least one support mounted between outsides of the corresponding two adjacent glass tubes, wherein each of the at least one support has a length matching a distance between the two through holes, where the corresponding adjacent glass tubes are inserted.

4. The LED light bulb as claimed in claim 2, wherein each glass tube comprises:
a cylinder body, wherein the inner space is defined, having a bottom opening and a bottom edge around the bottom opening;
a bell-shaped bubble received inside the cylinder body from the bottom opening, wherein a bottom of the bell-shaped bubble is integrally connected to bottom edge of the cylinder body; and
an airtight pipe downwardly extending from a top of the bell-shaped bubble and communicating with an inner space of the cylinder body.

5. The LED light bulb as claimed in claim 3, wherein each glass tube comprises:
a cylinder body, wherein the inner space is defined, having a bottom opening and a bottom edge around the bottom opening;
a bell-shaped bubble received inside the cylinder body from the bottom opening, wherein a bottom of the bell-shaped bubble is integrally connected to bottom edge of the cylinder body; and
an airtight pipe downwardly extending from a top of the bell-shaped bubble and communicating with an inner space of the cylinder body.

6. The LED light bulb as claimed in claim 5, wherein the inner space is filled with gas having high heat conductive coefficient.

7. The LED light bulb as claimed in claim 6, wherein the gas is inert gas or nitrogen.8. The LED light bulb as claimed in claim 1, wherein the AC to DC converting circuit board has multiple AC to DC power converters, each of which comprises:
a full bridge rectifier having inputs respectively and electronically connected to the AC power inputs, and outputs respectively and electronically connected to the DC power outputs;
a current limiting resistor electronically connected between one of the AC power inputs and one of the inputs of the full bridge rectifier; and
a capacitor electronically connected between one of the outputs of the full bridge rectifier and one of the DC power outputs.

9. The LED light bulb as claimed in claim 2, wherein the AC to DC converting circuit board has multiple AC to DC power converters, each of which comprises:
a full bridge rectifier having inputs respectively and electronically connected to the AC power inputs, and outputs respectively and electronically connected to the DC power outputs;
a current limiting resistor electronically connected between one of the AC power inputs and one of the inputs of the full bridge rectifier; and
a capacitor electronically connected between one of the outputs of the full bridge rectifier and one of the DC power outputs.

10. The LED light bulb as claimed in claim 3, wherein the AC to DC converting circuit board has multiple AC to DC power converters, each of which comprises:
a full bridge rectifier having inputs respectively and electronically connected to the AC power inputs, and outputs respectively and electronically connected to the DC power outputs;
a current limiting resistor electronically connected between one of the ii AC power inputs and one of the inputs of the full bridge rectifier; and
a capacitor electronically connected between one of the outputs of the full bridge rectifier and one of the DC power outputs.

11. The LED light bulb as claimed in claim 4, wherein the AC to DC converting circuit board has multiple AC to DC power converters, each of which comprises:
a full bridge rectifier having inputs respectively and electronically connected to the AC power inputs, and outputs respectively and electronically connected to the DC power outputs;
a current limiting resistor electronically connected between one of the AC power inputs and one of the inputs of the full bridge rectifier; and
a capacitor electronically connected between one of the outputs of the full bridge rectifier and one of the DC power outputs.

12. The LED light bulb as claimed in claim 5, wherein the AC to DC converting circuit board has multiple AC to DC power converters, each of which comprises:
a full bridge rectifier having inputs respectively and electronically connected to the AC power inputs, and outputs respectively and electronically connected to the DC power outputs;
a current limiting resistor electronically connected between one of the AC power inputs and one of the inputs of the full bridge rectifier; and
a capacitor electronically connected between one of the outputs of the full bridge rectifier and one of the DC power outputs.

13. The LED light bulb as claimed in claim 7, wherein the AC to DC converting circuit board has multiple AC to DC power converters, each of which comprises:
a full bridge rectifier having inputs respectively and electronically connected to the AC power inputs, and outputs respectively and electronically connected to the DC power outputs;
a current limiting resistor electronically connected between one of the AC power inputs and one of the inputs of the full bridge rectifier; and
a capacitor electronically connected between one of the outputs of the full bridge rectifier and one of the DC power outputs.14. The LED light bulb as claimed in claim 1, wherein the power plug is an E27, E14 or B22 Edisson screw, or G7, G10, G11, G23 or G24 pin plug.

15. The LED light bulb as claimed in claim 2, wherein the power plug is an E27, E14 or B22 Edisson screw, or G7, G10, G11, G23 or G24 pin plug.

16. The LED light bulb as claimed in claim 3, wherein the power plug is an E27, E14 or B22 Edisson screw, or G7, G10, G11, G23 or G24 pin plug.

17. The LED light bulb as claimed in claim 4, wherein the power plug is an E27, E14 or B22 Edisson screw, or G7, G10, G11, G23 or G24 pin plug.

18. The LED light bulb as claimed in claim 5, wherein the power plug is an E27, E14 or B22 Edisson screw, or G7, G10, G11, G23 or G24 pin plug.

19. The LED light bulb as claimed in claim 7, wherein the power plug is an E27, E14 or B22 Edisson screw, or G7, G10, G11, G23 or G24 pin plug.

20. The LED light bulb as claimed in claim 13, wherein the power plug is an E27, E14 or B22 Edisson screw, or G7, G10, G11, G23 or G24 pin plug.
